(19) United States
(12) Patent Application Publication
(10) Pub. No.: US 2025/0245896 A1
(43) Pub. Date: Jul. 31, 2025

(54) METHOD AND ELECTRONIC DEVICE FOR SUPPORTING ARTIFICIAL INTELLIGENCE-BASED AI CONTENT SERVICE, AND RECORDING MEDIA THEREOF

(71) Applicant: SAMSUNG ELECTRONICS CO., LTD., Suwon-si (KR)

(72) Inventors: Nagyeom YOO, Suwon-si (KR); Jihun MUN, Suwon-si (KR); Yongjoon JEON, Suwon-si (KR)

(21) Appl. No.: 19/055,881

(22) Filed: Feb. 18, 2025

Related U.S. Application Data
(63) Continuation of application No. PCT/KR2025/000817, filed on Jan. 14, 2025.

(30) Foreign Application Priority Data
Jan. 29, 2024 (KR) 10-2024-0013513
Mar. 18, 2024 (KR) 10-2024-0037264

(51) Int. Cl. G06T 11/60; G06F 3/14

(52) U.S. Cl. CPC G06T 11/60; G06F 3/14

(57) ABSTRACT

An electronic device according to an embodiment may include: a display, at least one processor, comprising processing circuitry, and a memory configured to store instructions that are executable by the processor. At least one processor, individually and/or collectively, may be configured to execute the instructions and to cause the electronic device to: based on a request to generate artificial intelligence (AI) content, identify an object included in first content displayed on the display; obtain first information associated with at least one of the object or the first content, and second information associated with the electronic device or a user; generate a prompt for input to a generative AI model, based on at least one of the first content, the first information, and the second information; and generate second content, associated with the first contest and personalized, using generative AI having an input of the generated prompt.

### CROSS-REFERENCE TO RELATED APPLICATIONS

This application is a continuation of International Application No. PCT/KR2025/000817 designating the United States, filed on Jan. 14, 2025, in the Korean Intellectual Property Receiving Office and claiming priority to Korean Patent Application Nos. 10-2024-0013513, filed on Jan. 29, 2024, and 10-2024-0037264, filed on Mar. 18, 2024, in the Korean Intellectual Property Office, the disclosures of each of which are incorporated by reference herein in their entireties.

### BACKGROUND

### Field

The disclosure relates to a method and an electronic device for supporting an AI content service using generative artificial intelligence, and a recording medium thereof.

### Description of Related Art

Recently, as interest in online learning environments has increased, there has been a growing interest in an online education system using an electronic device. The online education system has the advantage of overcoming time and space constraints and enabling low-cost education, as well as the advantage of being able to provide customized services that provide level-based education segmented according to learners' personalities and abilities.

Current online education systems digitize pre-secured or pre-existing (or conventional) educational data and filter or arrange the digitized data to match users so as to provide content for education. Although such online education systems may use existing data to select and provide content that matches learners' attributes (e.g., age, learning level, etc.), it may be difficult to provide new types of content or personalized content that is not available in existing data.

Artificial intelligence (AI) technology has developed rapidly in recent years. In particular, the development of AI functions has led to the rapid growth of generative AI technologies. Generative AI may refer to AI technology that newly generates similar content based on existing content such as text, audio, and/or images using machine learning and deep learning technologies.

### SUMMARY

Embodiments of the disclosure provide a method and a device that, using generative AI, may generate new AI content that is personalized according to a user's interests, departing from standardized existing data, and provide optimized, customized education to learners.

Embodiments of the disclosure provide a method and a device that can improve the responsiveness of camera zoom performance.

However, the problem to be addressed in the disclosure is not limited to the above problem, and may be expanded in various ways without departing from the spirit and scope of the disclosure.

An electronic device according to an example embodiment may include: a display, at least one processor, comprising processing circuitry, and a memory configured to store instructions that are executable by at least one processor, at least one processor, individually and/or collectively, may be configured to execute the instructions and to: based on a request to generate artificial intelligence (AI) content, identify an object included in first content displayed on the display; obtain first information associated with at least one of the object or the first content, and second information associated with the electronic device or a user; generate a prompt for input to a generative AI model, based on at least one of the first content, the first information, and the second information; and generate second content, associated with the first contest and personalized, using generative AI having an input of the generated prompt.

A method of supporting an AI content service of an electronic device according to an example embodiment may include: identifying an object included in first content displayed on a display, based on a request to generate artificial intelligence (AI) content; obtaining first information associated with at least one of the object or the first content, and second information associated with the electronic device or a user; generating a prompt for input to a generative AI model, based on at least one of the first content, the first information, and the second information; and generating second content, which is associated with the first contest and personalized, using generative AI having an input of the generated prompt.

The electronic device of the disclosure may include a non-transitory computer-readable recording medium in which a program for executing a method of supporting an AI content service is recorded.

An electronic device, a method, and a recording medium thereof according to various example embodiments may generate personalized AI content using content selected by a user from among content displayed on a display of the electronic device, and may use the generated AI content to provide customized education or learning services to the user.

The effects that can be obtained from the disclosure are not limited to those mentioned above, and various other effects not mentioned may be directly or indirectly understood by a person skilled in the art to which the disclosure belongs from the following description.

### BRIEF DESCRIPTION OF THE DRAWINGS

With regard to the description of the drawings, similar reference numerals may be used to refer to similar or related elements. Further, the above and other aspects, features and advantages of certain embodiments of the present disclosure will be more apparent from the following detailed description, taken in conjunction with the accompanying drawings, in which:

FIG. 1A is a block diagram illustrating an example electronic device in a network environment according to various embodiments;

FIG. 1B is a diagram illustrating an example configuration of a generative AI system according to various embodiments;

FIG. 2 is a diagram illustrating example configurations associated with generative AI of an electronic device according to various embodiments;

FIG. 3 is a diagram illustrating an example method of generating AI content by an electronic device according to various embodiments;

FIG. 4 is a diagram illustrating an example method of operating an AI content service of an electronic device according to various embodiments;

FIG. 5 is a diagram illustrating an example method for AI content service based on artificial intelligence of an electronic device according to various embodiments;

FIG. 6 is a diagram illustrating examples of learning setting user interface screens for AI content of an electronic device according to various embodiments;

FIG. 7 is a diagram illustrating examples of user interface screens for generating AI content of an electronic device according to various embodiments;

FIGS. 8A, 8B, 8C and 8D are diagrams illustrating example user display screens supporting AI content services of an electronic device according to various embodiments;

FIG. 9 is a diagram illustrating example user interface screens for collecting an AI content DB of an electronic device according to various embodiments;

FIG. 10 is a diagram illustrating example user interface screens for collecting a content DB of an electronic device and generating AI content according to various embodiments;

FIG. 11 is a diagram illustrating example user interface screens supporting an AI content service of an electronic device according to various embodiments; and

FIG. 12 is a diagram illustrating an example method of supporting AI content services of an electronic device according to various embodiments.

### DETAILED DESCRIPTION

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

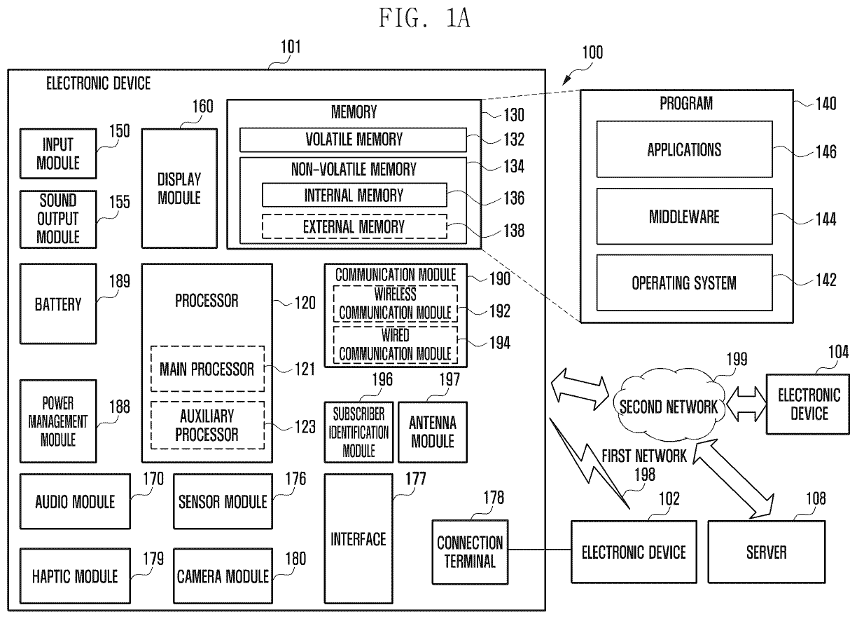

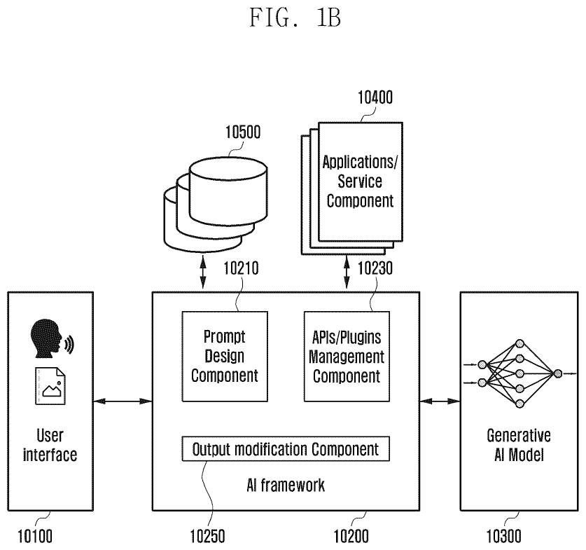

FIG. 1A is a block diagram illustrating an example electronic device in a network environment according to various embodiments.

Referring to FIG. 1A, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In various embodiments, at least one (e.g., the display device 160 or the camera module 180) of the components may be omitted from the electronic device 101, or one or more other components may be added in the electronic device 101. In various embodiments, some of the components may be implemented as single integrated circuitry.

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device 101 according to an embodiment may support generative artificial intelligence (AI) (or on-device AI) functions/services. Generative AI functions may refer to technologies that generate new content based on previously learned data and may utilize given input data or information to generate new forms of AI content. For example, generative AI may generate new content based on previously learned data, and may also be applied to operations such as improving the quality of an image or editing a video.

The electronic device 101 according to an embodiment may support generative AI functions (or AI services) in conjunction with the server 108. At least one of the electronic device 101 or the server 108 according to an embodiment may include the configuration of a generative AI system illustrated in FIG. 1B.

For example, FIG. 1B illustrates an example configuration of a generative AI system according to various embodiments. As shown in FIG. 1B, the generative AI system may include a user interface 10100, an AI framework 10200, a generative AI model 10300, an application and service component 10400, and a database component 10500.

The user interface (e.g., user query/response interface) 10100 according to an embodiment may receive input of a user query. The user query input may be in the form of natural language, images, and video. The user interface 10100 may transmit context information as well as data about the user query input to the AI framework 10200. The context information may include various pieces of additional information at the time of user input. In addition, the user query input may be in the form of a mixture of the natural language, image, sound, and context information described above. Additionally, the user query input may be in a non-natural language form, such as a menu selection (e.g., a request to generate or a request to modify), that does not generate natural language. The user interface 10100 may output a result from the generative artificial intelligence system to a user. The result may be in the form of natural language or specific content, and may also be provided in the form of an action and the like, requested by a user.

The AI framework 10200 according to an embodiment may receive a user query input, and coordinate and control each of components required to perform the user's intent, based on the user's query input. As such, the AI framework 10200 may include a prompt design component 10210, an application and plugin management component (APIs/Plugins management component) 10230, and an output modification component 10250.

User queries or actions input in the user interface 10100 according to an embodiment may be transmitted to the prompt design component 10210. The prompt design component 10210 may be used to generate prompts suitable for input to a large language model (LLM) or large multimodal models (LMMs). The prompt design component 10210 may be an AI component that uses a machine learning algorithm or neural network to develop better prompts over time. The prompt design component 10210 may access a database component 10500 (e.g., a knowledge component) including user preference data, a prompt library, and prompt examples to generate prompts, and may transfer the generated prompts to the large language model (LLM) or large multimodal models (LMMs).

The APIs/Plugins management component 10230 according to an embodiment may serve to communicate with external information in case that there is a request for additional information when transferring a user input to the input of the generative model. The APIs/Plugins management component 10230 may build a channel capable of communicating with the outside of the application and service component 10400 (e.g., the AI Interface) via an application programming interface (API), thereby enabling access to various data sources. In addition, the APIs/Plugins management component 10230 may, in case that the application and service needs to perform an action of finally performing a user query, rather than an intermediate result, request the corresponding action from the API. The information obtained from the outside may be transferred along with the user input to the input of the generative model.

The output modification component 10250 according to an embodiment may fine-tune a result output from the generative model. For example, the output modification component 10250 may verify that the content generated by the language model (LLM) or large-scale multimodal model (LMM) is not irrelevant, does not contain biased content, or does not contain harmful content. In addition, the output modification component 10250 may determine a degree to which the result matches a user's desired result and proceed with additional processes if necessary. Additionally, the output modification component 10250 may configure hints to avoid unwanted output and provide the hints to the user.

The generative AI model 10300 according to an embodiment may generally refer to an artificial intelligence neural network that generates new forms of data based on a user input information. A model that generates images may typically include, for example, and without limitation, a generative adversarial network (GAN), a variational auto encoder (VAE), or the like. For example, the generative AI model may be a diffusion-based generative model that uses a VAE and a transformer structure. In addition, a language-generating model may refer to a model that is trained to output the most statistically relevant output value based on an input value. In the generative AI model 10300, a language-generating model may be, for example, and without limitation, a model such as CHAT-GPT 3 and CHAT-GPT 4, or the like. As another example, large multimodal models (LMMs) may be models that can recognize various forms of data input such as text, images, and voices and generate new data corresponding thereto.

According to an embodiment, the memory 130 may store instructions executable by the processor 120 or the electronic device 101. These instructions may include control instructions such as arithmetic and logic operations, data movement, or input/output that may be processed by the processor 120.

According to an embodiment, the processor (e.g., including processing circuitry) 120 may be operatively, functionally, and/or electrically connected to a display (e.g., the display module 160, the touchscreen display) and/or the memory 130. The processor 120 may be configured to perform computation or data processing for control and/or communication of the respective components of the electronic device 101, and may be formed of one or more processors. There is no limitation to the computation and data processing functions that the processor 120 is able to implement on the electronic device 201, but in the disclosure, various operations related to AI content services for education or learning may be processed. For example, the electronic device 101 according to an embodiment may be implemented to provide AI content services using a part of the AI system of FIG. 1B.

Referring to FIG. 1A, the electronic device 101 according to an embodiment may include a display (e.g., the display module 160), a processor 120, and a memory 130 storing instructions executable by the processor 120. The instructions according to an embodiment may cause the electronic device 101 or the processor 120 may be configured to, based on a request to generate AI content, to identify an object included in the first content displayed on the display. As used herein, the terms “instructions may cause” and “processor configured to” may be used interchangeably to refer to situations in which the instructions, when executed cause an operation to be performed and/or at least one processor, individually and/or collectively, configured to cause an operation to be performed. The instructions according to an embodiment may cause the electronic device 101 or the processor 120 to obtain first information associated with at least one of the object or the first content, and second information associated with the electronic device 101 or user. The instructions according to an embodiment may cause the electronic device 101 or the processor 120 to, based on at least one of the first content, the first information, and the second information, generate prompts for input to the generative artificial intelligence model. The instructions according to an embodiment may cause the electronic device 101 or the processor 120 to, generate second content associated with the first content and personalized using generative artificial intelligence (AI) having the generated prompts as input.

The second content according to an embodiment may include artificial intelligence (AI) content, educational content, or learning content.

The instructions according to an embodiment may cause the electronic device 101 or the processor 120 to extract, as the first information, at least one of object identification information, a content-describing keyword used for analyzing the first content or the identified object, and additional information based on metadata of the content.

The instructions according to an embodiment may cause the electronic device 101 or the processor 120 to extract, as the second information, at least one of user learning setting information, user app usage information, user profile information, and context information.

The instructions according to an embodiment may cause the electronic device 101 or the processor 120 to select and extract the second information associated with the first information.

The instructions according to an embodiment may, as an operation of identifying the object by the electronic device 101 or processor 120, identify the object through user input selecting the object included in the first content or through recognition of the object in the first content.

The instructions according to an embodiment may cause the electronic device 101 or the processor 120 to display the second content on the display.

The second content according to an embodiment may include a content or object image, object identification information, a type of generated AI content, and a content description.

The instructions according to an embodiment may cause the electronic device 101 or the processor 120 to display the second content in the form of a pop-up window overlaid on the first content, or to switch the second content into the form of a foreground and then display the switched second content.

The instructions according to an embodiment may cause the electronic device 101 or the processor 120 to, in case that source information of the content description is different, apply different visual effects to the text of the content description and display so that the text of the content description is visually distinguished according to the source information.

The instructions according to an embodiment may cause the electronic device 101 or the processor 120 to obtain edition information in which the AI content associated with the second content has been modified or changed, or feedback information regarding the result of learning of the second content.

The instructions according to an embodiment may cause the electronic device 101 or the processor 120 to update the second content, based on the obtained edition information or the feedback information.

The instructions according to an embodiment may cause the electronic device 101 or the processor 120 to, based on selecting the first content displayed on the display, display a second content generation item and a data collection item on at least a part of the display and, based on selection of the second content generation item or recognition of the object included in the first content, receive the request to generate the AI content.

In the following description of the electronic device 101 according to an embodiment of the disclosure, components that are substantially identical or similar to those of embodiments illustrated in FIGS. 1A and 1B described above are given the same reference numerals, and redundant descriptions of their functions may not be repeated.

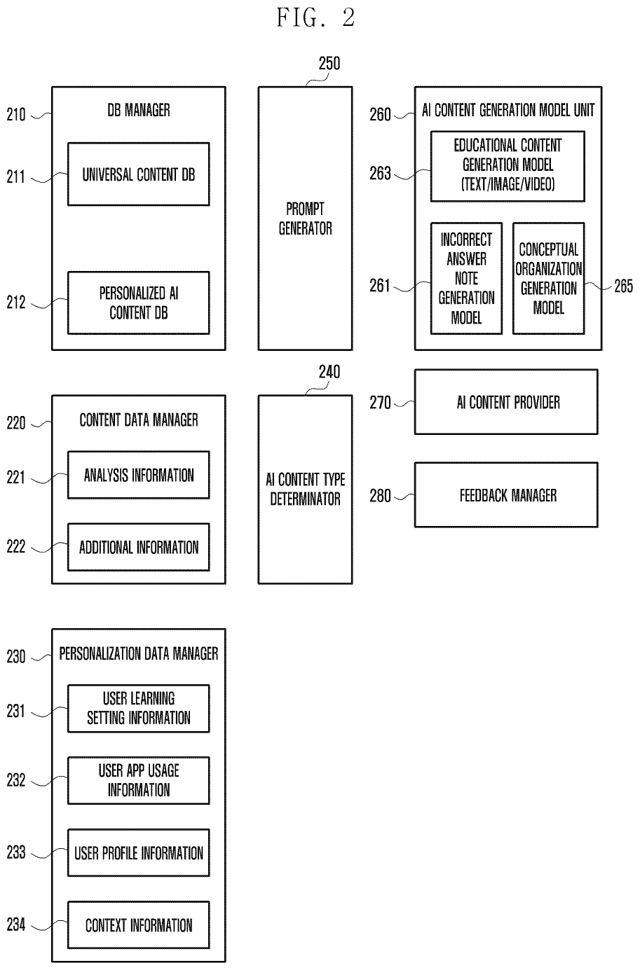

FIG. 2 is a diagram illustrating example configurations associated with generative AI of an electronic device according to various embodiments.

Referring to FIG. 2, the electronic device 101 according to an embodiment may include configurations supporting AI content services using generative AI. For example, the processor 120 of the electronic device 101 may include at least one of a DB manager 210, a content data manager 220, a personalization data manager 230, an AI content type determinator 240, a prompt generator 250, an AI content generation model unit 260, an AI content provider 270, and a feedback manager 280, each of which may include various circuitry and/or executable program instructions.

According to an embodiment, the DB manager 210 may perform control to manage and update a universal (or common) content DB 211 and a personalized AI content DB 212. The DB manager 210 may store pre- or pre-made educational content in the universal content DB 211. The DB manager 210 may store or update AI content (e.g., AI educational content) generated in response to a user request in the personalized AI content DB 212. For example, the personalized AI content DB may include at least one of AI content (or educational content or second content), content data (or first information), and personalization data (or second information).

According to an embodiment, the DB manager 210 may store (or update), in the personalized AI content DB 212, the first information (e.g., analysis information 221, additional information 222) transferred from the content data manager 220 and the second information (e.g., user learning setting information 231, user app usage information 232, user profile information 233, and context information 234) transferred from the personalization data manager 230.

According to an embodiment, the DB manager 210 may store, in the personalized AI content DB 212, analysis information and/or images obtained by capturing test papers or question papers completed by the user himself/herself.

According to an embodiment, the electronic device 101 may communicate with a server to update the universal content DB 211 and/or transfer AI content stored in the personalized AI content DB 212 to the server.

According to an embodiment, the content data manager (or first information manager) 220 may extract first information (e.g., analysis information 221 of the content or object and/or additional information 222 based on metadata of the content). The content data manager 220 may transfer the first information to the prompt generator 250, or may transfer the same to the DB manager 210. The analysis information 221 may include at least a part of object identification information and content-describing keywords. The additional information 222 may refer to information based on metadata of the content or object (e.g., date, time, place, etc.).

Although not shown, the content information manager 220 may further include a content analyzer (not shown). The content analyzer may analyze designated content (e.g., content selected by a user input) to recognize at least one object in the content and identify identification information of the object.

According to an embodiment, the personalization data manager (or second information manager) 230 may extract second information associated with the first information (e.g., at least one of user learning setting information 231, user app usage information 232, user profile information 233, and context information 234), and transfer the second information to the prompt generator 250. The user learning setting information 231 may include at least one of, for example, a learning mode, a learning language, an AI content type, an AI content field, a learning level, and an app capable of supporting the learning mode. The user app usage information 232 may refer to application information running on the electronic device (e.g., browser app, music app, movie app, etc.). The user profile information 233 may include at least one of user age, gender, learning patterns, learning grades, and learning level information based on the result of learning. The context information 234 may refer to information extracted through recognizing a situation of the electronic device and/or the user (e.g., a situation in which the electronic device is connected to other electronic devices, a situation of a meeting, the situation in which the user is located at home, etc.).

According to an embodiment, the AI content type determinator 240 may determine at least one of an AI content type and/or a user interface (UI) configuration based on at least one of the user learning setting information, the learning pattern, and the second information. For example, the AI content type determinator 240 may recognize a situation of the electronic device or user (e.g., a situation in which the electronic device is connected to a speaker device and is located inside a home) based on context information, and may determine a UI configuration and/or a type of AI content that matches to the situation (e.g., content where the sound of a question is output through the speaker device and the electronic device displays candidates of correct answers).

According to an embodiment, the prompt generator 250 may generate a prompt for AI content generation, based on at least one of the content, the first information, and the second information, and may transfer the generated prompt to the AI content generation model unit 260. For example, the prompt generator 250 may list the information extracted at the time of generation of the prompt and transfer the information to the AI content generation model, or may transmit a prompt, which is converted to a natural language format using the extracted information, to the input of the AI content generation model.

According to an embodiment, the AI content generation model unit 260 may use, as input data for the AI content generation model (or AI model, AI engine), at least one of a prompt transferred from the prompt generator 250, a DB (e.g., the universal content DB 211, the personalized AI content DB 212), and content selected by a user (e.g., first content). The AI content generation model unit 260 may generate AI content using the AI content generation model (or AI model, AI engine). For example, the AI content generation model may include at least one of an incorrect answer note generation model 261, an educational content generation model 263, and a conceptual organization generation model 265. Although not shown in the drawing, the AI content generation model may further include a user pattern generation model (not shown) that records a user's learning patterns for the AI content and is modeled by learning the learning pattern or feedback information. The user pattern generation model may refer to a generation model that is modeled to generate AI content that is reflected in personal characteristics. For example, the educational content generation model 263 may use at least one of a text generation model, an image generation model, and a video generation model, and content similar to the educational content may be generated through the above-described models.

According to an embodiment, the AI content generation model unit 260 may generate AI content by selecting an AI content generation model that matches a content type determined via the AI content type determinator. For example, in case that a prompt for producing a video lecture is input with respect to first content including images, the electronic device 101 may generate video lecture AI content, based on the first content.

According to an embodiment, the AI content provider 270 may perform control to display, on the display, the generated AI content to match a UI configuration. For example, the UI configuration of the AI content may include a content or object image, object identification information, a type of generated AI content, and a content description. The AI content provider 270 may, in case that source information of the content description is different, apply different visual effects to the text of the content description and display so that the text of the content description is visually distinguished according to the source information. For example, AI-generated text in the content description may be colored black, text based on first information may be colored purple, or text based on second information may be colored blue.

According to an embodiment, in case that the AI content is edited (or modified, changed) by a user after the user has learned the AI content, or in case that the feedback information is received, the feedback manager 280 may transfer the edited information and/or feedback information to the DB manager 210 and update the universal content DB 211 or the personalized AI content DB 212.

In the following example embodiments, each of the operations is accomplished through the interaction of the processor 120 and the memory 130, and may be operated through software modules (e.g., configurations implemented on a framework) implemented in connection with each of the operations. Hereinafter, each of the operations may be performed sequentially, but is not necessarily performed sequentially. For example, the order of the operations may be changed, and at least two operations may be performed in parallel.

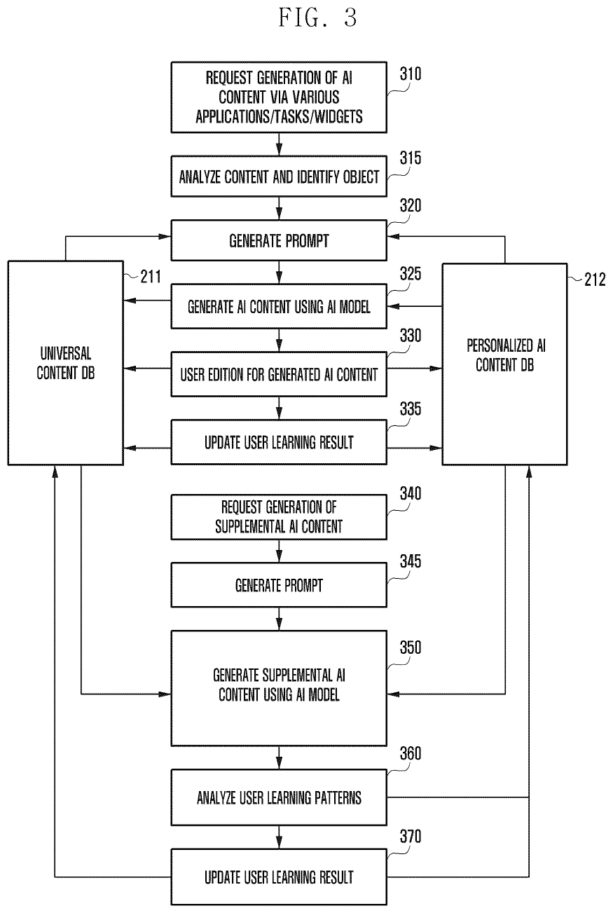

FIG. 3 is a diagram illustrating an example method of generating AI content by an electronic device according to various embodiments.

Referring to FIG. 3, according to an embodiment, the electronic device 101 may support an AI educational content service (or an AI educational content function, an AI learning mode) that generates AI educational content associated with a user's interests (e.g., selected content) using AI and enables learning thereof.

In operation 310, the processor 120 of the electronic device 101 may receive an input requesting to generate AI content via at least one of an application, a task, or a widget. For example, the processor 120 may display a UI menu associated with AI content (e.g., an AI content generation item), based on a user input selecting content (e.g., first content) displayed on the display based on at least one of the application, task, or widget, or based on recognizing an object included in the content. The processor 120 may receive an input selecting an AI content generation item displayed on the display (e.g., an input requesting to generate AI content).

In operation 315, the processor 120 may analyze the content and identify an object included in the content.

For example, the processor 120 may analyze first content selected by a user or first content, in which the object is recognized, and extract first information (or content data) to identify the object included in the content. The processor 120 may extract second information (or personalization data) associated with the first information, and may transfer at least one of the content, the first information, and the second information to the prompt generator 250. The first information may include analysis information 221 of the content or object and/or additional information 222 based on metadata of the content. The second information may include at least one of user learning setting information 231, user app usage information 232, user profile information 233, and context information 234.

In operation 320, the processor 120 may generate a prompt for generating AI content. The processor 120 may generate the prompt for generating the AI content based on at least one of the content, the first information (or content data), and the second information (or personalization data).

In operation 325, the processor 120 may generate AI content (e.g., AI educational content, second content) using an AI model (or AI content generation model). For example, the AI model (e.g., AI content generation model) may include at least one of an incorrect answer note generation model 261, an educational content generation model 263, a conceptual organization generation model 265, or a user pattern generation model (not shown).

The processor 120 may determine a type of AI content that matches the learning setting information or personalized characteristics, and may select an AI model corresponding to the determined type to generate the AI content.

According to an embodiment, the processor 120 may generate content-related and personalized AI content using DBs (e.g., the general content DB 211, the personalized AI content DB 212) associated with the generated prompts and educational services as input values for the AI model.

The processor 120 may display the generated AI content on the display.

In operation 330, the processor 120 may obtain user edition information for the generated AI content.

For example, the processor 120 may perform switching to an editing UI screen allowing editing of the AI content description, based on a request for edition of the AI content displayed on the display, and obtain edition information (or edition data) in which the AI content description has been modified or changed through an edit UI.

According to an embodiment, operation 330 may be omitted.

In operation 335, the processor 120 may update the universal content DB 211 and/or the personalized AI content DB 212 with the edition information or the result of user learning (or feedback information).

In operation 340, the processor 120 may receive a request to generate supplemental AI content.

According to an embodiment, the processor 120 may receive an input requesting change to a type of the AI content, or requesting supplement of the AI content in response to feedback on the generated AI content (e.g., problem solving).

For example, the processor 120 may recognize that a request to generate supplemental AI content has been received when educational content is needed for explanation by incorrect answer information based on the user's problem-solving results for the AI content, or when new questions need to be generated by considering the process required for learning.

In operation 345, the processor 120 may generate prompts for generation of supplemental AI content.

For example, the processor 120 may extract second information that matches supplemental characteristics in connection with the request to generate supplemental AI content among the second information, and modify the input of the second information to generate an updated prompt.

In operation 350, the processor 120 may generate supplemental AI content (e.g., AI educational content, third content) using an AI model (e.g., an AI content generation model).

For example, the processor 120 may generate supplemental AI content that corresponds to the pre-generated AI content.

In operation 360, the processor 120 may analyze learning patterns of the user who has learned the supplemental AI content, and in operation 370, the processor 120 may update the universal content DB 211 and/or the personalized AI content DB 212 with the result of user learning.

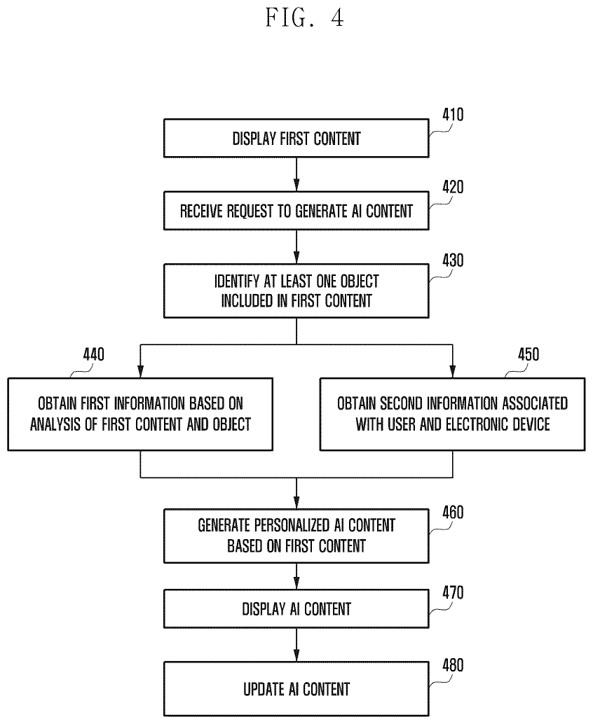

FIG. 4 is a diagram illustrating an example method of operating an AI content service of an electronic device according to various embodiments.

Referring to FIG. 4, the processor 120 of the electronic device 101 according to an embodiment may display first content on a display in operation 410. For example, the processor 120 may execute applications/tasks/functions (e.g., gallery, camera, screen capture, AR app, book app, video viewer app, fashion app, and SNS app) that are capable of supporting AI services, based on user input, and may display the first content (e.g., text, image, or video).

In operation 420, the processor 120 may receive a request to generate AI content associated with the first content displayed on the display.

For example, the processor 120 may display, on the display, a menu item for generating AI content (or AI educational content, second content, learning content) associated with the first content, based on an input of selecting the first content. The processor 120 may, in case that an input of selecting a menu item for AI content generation is received, recognize that a request to generate AI content has been received.

The electronic device 101 according to an embodiment may receive a request to generate AI content associated with an image (or object) currently displayed on the display, via a user's voice using an artificial intelligence assistant or via text input using various interfaces.

In operation 430, the processor 120 may identify at least one object included in the first content displayed on the display. For example, the processor 120 may identify the at least one object included in the first content when a user selects the object included in the first content or when the object included in the first content is recognized (e.g., automatically recognized) through an application capable of supporting AI services.

In operation 440, the processor 120 may obtain first information (or content data) based on the analysis of the first content and the object. For example, the first information may include analysis information 221 of the content and object and additional information 222 based on metadata. The analysis information 221 may include at least a part of object identification information, content-describing keywords, and the like. The processor 120 may extract additional information 222 based on the metadata of the selected content or object. The additional information 222 may refer to information based on the metadata of the content or object (e.g., date, time, place, etc.).

In operation 450, the processor 120 may obtain second information (or personalization data) associated with the first information and related to the user and the electronic device. For example, the second information may include at least one of the user learning setting information 231, the user app usage information 232, the user profile information 233, and the context information 234.

In operation 460, the processor 120 may generate personalized AI content based on the first content, based on at least one of the first content, the first information, and the second information.

For example, the processor 120 may generate a prompt for generating AI content based on at least one of the first content, the first information, and the second information. The processor 120 may use a prompt and a DB (e.g., the universal content DB 211 or the personalized AI content DB 212) as an input value to the AI content generation model to generate AI content that is associated with the first content and personalized. The processor 120 may determine a content type based on learning setting information or personal characteristics and generate AI content that matches the determined type.

In operation 470, the processor 120 may display the generated AI content on the display.

In an example, the processor 120 may display a UI screen (hereinafter, AI content UI screen) that provides AI content overlaid with at least a part of the content displayed on the display. For example, the AI content may include an image of an object recognized by a user or automatically, object identification information, information about the type of AI content generated, and a content description. In another example, the processor 120 may, depending on the form factor (e.g., foldable device) or split screen of the electronic device 101, display content in some areas of the display (e.g., a first display area), and display AI content generated based on the content in other areas of the display (e.g., a second display area).

According to an embodiment, the processor 120 may apply different visual effects (e.g., color, size, shape, font, etc.) to a content description 834 and display so that the content description is visually distinguished according to the source of information associated with the content description.

In operation 480, the processor 120 may update the AI content or data associated with the AI content, based on the information that the AI content has been edited or fed back.

For example, the processor 120 may support a function of editing the AI content and/or recording feedback information, and may update the personalized AI content DB 212, based on the edition information and feedback information in which the AI content has been edited by the user.

According to an embodiment, the electronic device 101 may be implemented as a wearable device. For example, the wearable device may include at least one of a watch type, an eyeglass type, or a ring type that may be worn on the body.

In an embodiment, a wearable device may support an AI content service based on at least one of a virtual reality, augmented reality, mixed reality, or extended reality device. For example, the wearable device may provide an AI content service by identifying an object in an image or scene provided via a display of the wearable device and generating AI content associated with the identified object. Alternatively, in case that the wearable device is implemented as a video see-through (VST) type, the wearable device may provide an AI content service by analyzing objects or scenes within a user-selected area of a preview image or video captured by the camera and generating AI content associated with the analyzed objects or scenes.

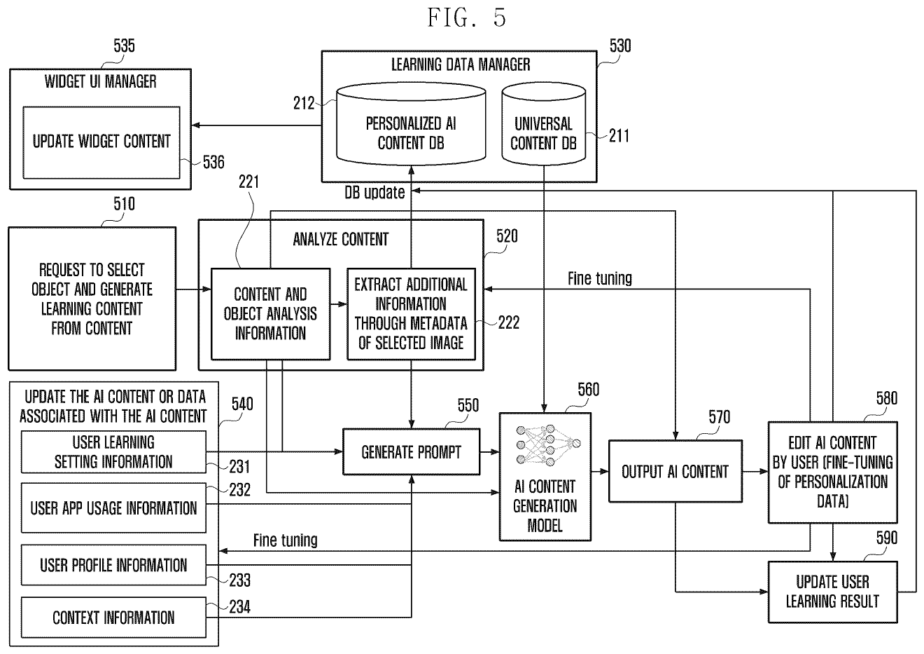

FIG. 5 is a diagram illustrating an example method for AI content service based on artificial intelligence of an electronic device according to various embodiments.

Referring to FIG. 5, the processor 120 of the electronic device 10 according to an embodiment may receive a request to select an object and generate learning content from content (e.g., first content) in operation 510.

For example, the electronic device 101 may display the first content on the display via applications (e.g., camera, gallery, Bixby vision, screen capture, AR app, book app, video viewer app, fashion app, and SNS app) that are capable of supporting AI services in a state in which an AI learning mode (or AI service education mode) is activated. The processor 120 may display an AI content generation menu item associated with the first content selected based on an input of selecting the first content displayed on the display or an object included in the first content. The processor 120 may perform operations for generating AI content (e.g., AI educational content, second content), based on the AI content generation menu item being selected.

In operation 520, the processor 120 may analyze the selected content (e.g., first content) and transfer first information (or content data) associated with the content or objects included in the content to the prompt generator 250. The first information may include analysis information 221 of the content and object and additional information 222 based on metadata. The analysis information 221 may include at least a part of object identification information and content-describing keywords. The additional information 222 may refer to information based on metadata of the content or object (e.g., date, time, place, etc.).

According to an embodiment, the processor 120 may extract analysis information 221 used for analysis of the selected content and the identified object within the content, and additional information 222 based on metadata of the selected content or object. For example, the processor 120 may automatically recognize objects in the content, extract object identification information for objects selected by the user, and extract descriptive keywords indicating characteristics of the content.

According to an embodiment, the processor 120 may transfer content (e.g., first content) and/or first information to the prompt generator 250.

According to an embodiment, the processor 120 may also update the personalized AI content DB 212 with the selected content and/or first information extracted from the selected content (e.g., additional information 222).

According to an embodiment, the processor 120 may also update the personalized AI content DB 212 with the selected content and/or first information extracted from the selected content.

In operation 530, the processor 120 may, via the DB manager 210, perform control such that at least one of the personalized AI content DB 212 and/or the universal content DB 211 is used as an input to the AI content generation model.

In operation 540, the processor 120 may transfer second information stored in the personalization data manager 230 (e.g., second information associated with the first content (or first information)) to the prompt generator 250. The second information may include at least one of user learning setting information 231, user app usage information 232, user profile information 233, and context information 234. The user learning setting information 231 may include at least one of, for example, a learning mode, a learning language, an AI content type, an AI content field, a learning level, and apps capable of supporting the learning mode. The user app usage information 232 may refer to application information running on the electronic device (e.g., browser app, music app, movie app, etc.). The user profile information 233 may include at least one of user age, gender, learning patterns, learning grades, and learning level information based on the result of learning. The context information 234 may refer to information extracted by recognizing a situation of the electronic device and/or the user (e.g., a situation in which the electronic device is connected to other electronic devices, a situation of a meeting, a situation in which the user is located at home, etc.).

For example, AI content type or screen UI configurations may be determined based on learning setting information or context information. The educational level of AI content may be determined based on user app (application) usage information and user profile information.

In operation 550, the processor 120 may generate a prompt for AI content generation based on at least one of the content, the first information, and the second information, and transfer the generated prompt to the AI content generation model.

In an embodiment, the processor 120 may list the information (e.g., text, images, etc.) extracted during prompt generation and transfer the information to the AI content generation model, or may use the extracted information to generate a prompt that is converted to a natural language format and transfer the prompt to the input of the AI content generation model.

In operation 560, the processor 120 may generate personalized AI content (e.g., AI educational content, second content) associated with content selected using an AI content generation model with data and prompts stored in the DB (e.g., universal (or common) content DB 211 and personalized AI content DB 212) as input.

In operation 570, the processor 120 may output (or display) the generated AI content on a display.

For example, the processor 120 may display a UI screen (hereinafter, the AI content UI screen) that provides AI content overlaid with at least a part of the content displayed on the display. The AI content UI screen may be displayed as a popup window, but is not limited thereto. In another example, the processor 120 may, depending on the form factor (e.g., foldable device) or split screen of the electronic device 101, display content in some areas of the display (e.g., a first display area), and display AI content generated based on the content in other areas of the display (e.g., a second display area).

In operation 580, the processor 120 may edit AI content information or feedback information by a user input.

According to an embodiment, the processor 120 may, when displaying AI content on a display, display an edition item that allows entry into an editing function (or editor mode) of the AI content according to a user request. Based on a user input of selecting the edition item, the processor 120 may perform switching to a UI screen (hereinafter, an editing UI screen) allowing editing of the AI content, and then obtain, through the editing UI screen, edition information about the AI content, based on edition information modified/changed by the user. The processor 120 may provide a function of recording feedback data about the AI content, and may obtain feedback information recorded by the user.

For example, the edition information may refer to information obtained by editing/modifying data of the AI content through the user's editing function. Feedback information may refer to evaluation/feedback information about the AI content after the user has learned the AI content (e.g., whether the learning level is appropriate, whether content that matches a user is recognized, etc.).

According to an embodiment, the processor 120 may store or update the AI content or edited AI content in the personalized AI content DB 212. The processor 120 may, in case that the information edited by the user is associated with the content data (or first information), perform control to update the analysis information or additional information of the image.

In operation 590, the processor 120 may update the AI content by recording the result of learning of the AI content, based on the edition information or feedback information. The processor 120 may update and manage the AI content stored in the personalized AI content DB 212.

According to an embodiment, the processor 120 may update (or tune, fine tune) the personalized AI content DB 212 and/or the user personalization data based on the results of the user's learning (e.g., problem solving, speaking responses) of the AI content and/or information obtained by analyzing the result of learning. For example, when it is determined that a description edited by the user is relevant to image analysis information, the electronic device 101 may perform tuning to transfer the description edited by the user to the configuration of processing image analysis, so as to extract more personalized keywords and output analysis results during image analysis. Alternatively, in case that a description edited by the user is a description associated with application usage information, the electronic device 101 may perform tuning to transfer the description edited by the user to the personalized AI DB, so as to output more personalized results during personalization data analysis.

In various embodiments, operation 580 or 590 may be omitted.

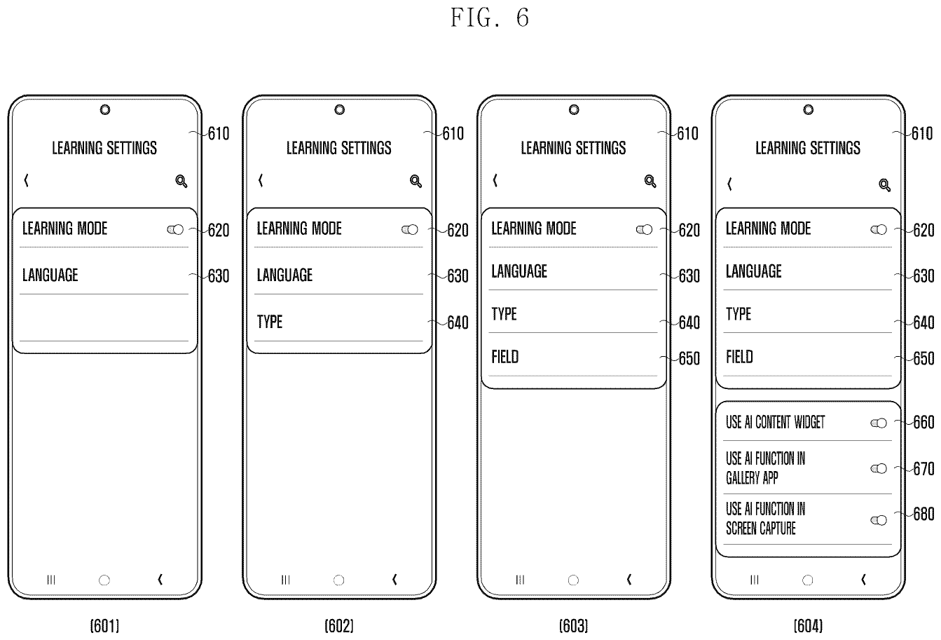

FIG. 6 is a diagram illustrating examples of learning setting user interface screens for AI content of an electronic device according to various embodiments.

Referring to FIG. 6, the electronic device 101 according to an embodiment may be provided with AI content service functions upon execution of specific applications/tasks/functions (e.g., gallery, camera, screen capture, AR app, book app, video viewer app, fashion app, and SNS app) that are capable of supporting AI services. For example, the electronic device 101 may be designed to automatically support AI content (or AI educational content), regardless of setting options.

According to an embodiment, the electronic device 101 may support the setting options for AI content. For example, the electronic device 101 may support changing setting information associated with the AI content via learning setting UI screens 610 shown in FIG. 6.

According to an embodiment, in case that the electronic device 101 only supports learning mode on/off and language settings, a learning setting UI screen 610 that includes an on/off setting item 620 and a language setting item 630, as shown in screen <601>, may be provided. The language setting item 630 may be an item to set a language to be used to generate AI content (or AI educational content) for foreign language education.

According to an embodiment, in case that the electronic device 101 additionally supports type settings, in addition to the setting items shown in screen <601>, the learning setting UI screen 610 that further includes a type setting item 640 may be provided as shown in screen <602>. The type setting item 640 may be an item to set the type of AI content, and may select at least one of, but not limited to, OPIC, TOEFL, TOEIC, JLPT, JPT, HSK, news, conversation, K-12 English Language Proficiency Assessment test, College Scholastic Ability Test, speaking examples, writing, and journal writing.

According to an embodiment, in case that the electronic device 101 additionally supports field settings, in addition to the setting items shown in screen <602>, the learning setting UI screen 610 that further includes a field setting item 650 may be provided as shown in screen <603>. The field setting item 650 may refer to an item to set a field of the AI content, and may select at least one of, but not limited to, social, historical, economic, political, daily, scientific, trending, or math.

According to an embodiment, in case that the electronic device 101 is designed to allow a user to set up an AI content supporting function in a widget or specific app, the learning setting UI screen 610 may include, for example, a learning mode on/off setting item 620, a language setting item 630, a type setting item 640, a field setting item 650, an AI content widget setting item 660, a galley app support setting item 670, and a screen capture support setting item 680, as shown in screen <604>.

The learning setting UI screens shown in FIG. 6 are merely examples and the disclosure is not limited thereto.

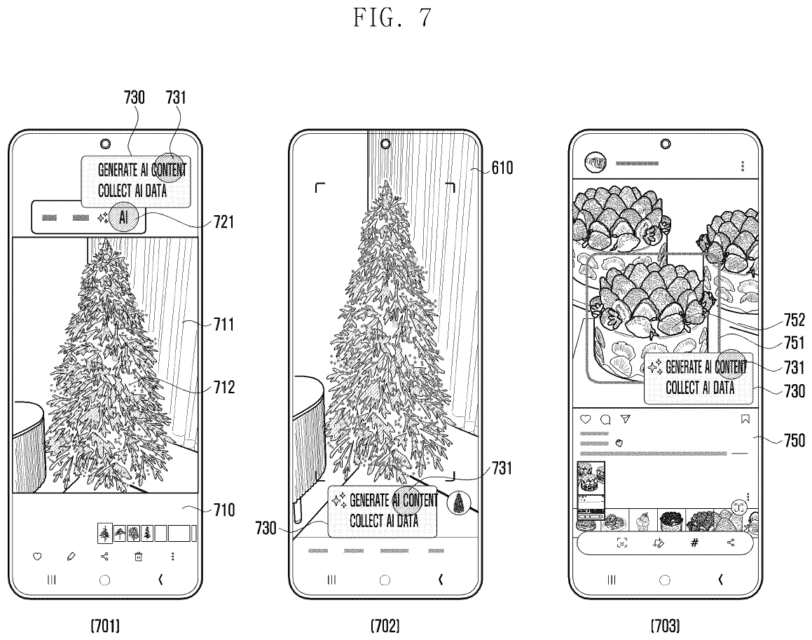

FIG. 7 is a diagram illustrating examples of user interface screens for generating AI content of an electronic device according to various embodiments.

Referring to FIG. 7, according an embodiment, the electronic device 101 may perform a function of generating AI content in conjunction with a function supported by a specific application. For example, the electronic device 101 may provide a menu UI associated with an AI content service (hereinafter, AI content menu UI) in conjunction with a function of identifying objects within content.

According to an embodiment, a gallery application may provide a function of displaying a first image (e.g., first content) 711, identifying, and separating an object 712 from a first image 711 (e.g., extracting an object contour), and an AI content service function. For example, as shown in screen <701>, the electronic device 101 may display an image-related menu UI 720, based on an input (or automatic object recognition) of selecting the first image 711 displayed on an execution screen 710 of the gallery application. For example, the image-related menu UI 720 may further include an AI item 721, an image share item, an image copy item, and an image save item, but this is only an example.

In case of receiving an input of selecting the AI item 721 from the image-related menu UI item 720, the electronic device 101 may display an AI content menu UI 730. The electronic device 101 may generate AI content (e.g., AI educational content) associated with the first image 711 and/or object 712, based on an input of selecting an AI content generation item 731.

According to an embodiment, a camera application (or AR application) may support a function of recognizing objects in an image or video (e.g., content) captured by a camera and the AI content service function. For example, as shown in screen <702>, the electronic device 101 may automatically recognize an object 741 in an image or video 740 captured through a camera function (e.g., Bixby vision) of supporting object identification, or display the AI content menu UI 730 based on an input of a user selecting the object 741. In screen <702>, the electronic device 101 may generate AI content (e.g., AI educational content) associated with the image or video 740 and/or the object 741, based on the input of selecting the AI content generation item 731.

According to an embodiment, a screen capture application may support a function of recognizing an object after capturing the screen of the electronic device 101 and an AI content service function. For example, as shown in screen <703>, the electronic device 101 may display a screen capture image 750 on a display based on a user request. The electronic device 101 may recognize an object region 751 and an object 752 in the screen capture image 750. The electronic device 101 may display the AI content menu UI 730 based on the recognition of the object 752. In screen <703>, the electronic device 101 may generate AI content (e.g., AI educational content) associated with object 752 recognized in the screen capture image 750, based on the input of selecting the AI content generation item 731.

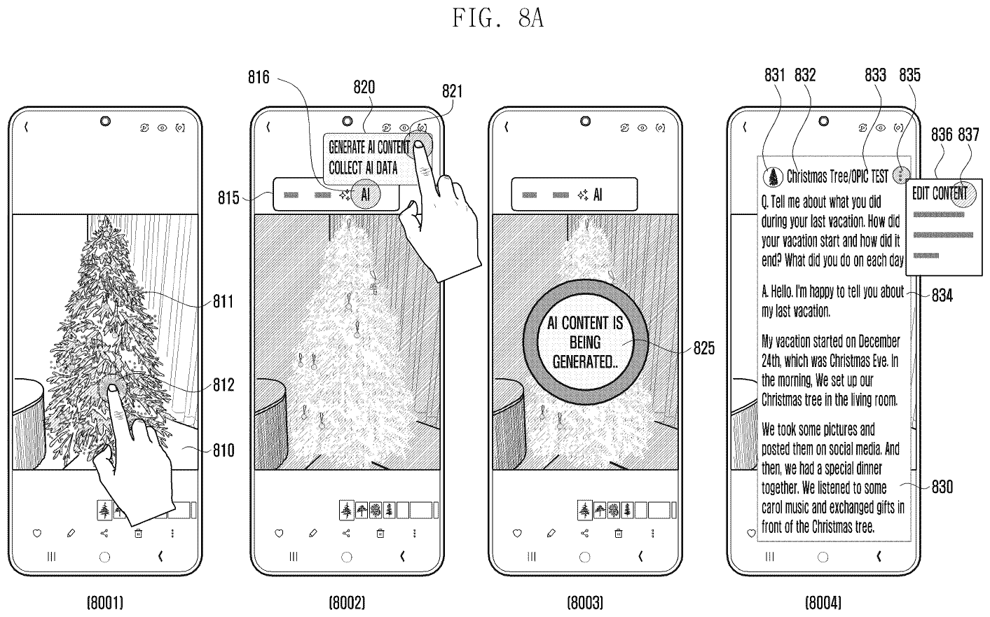

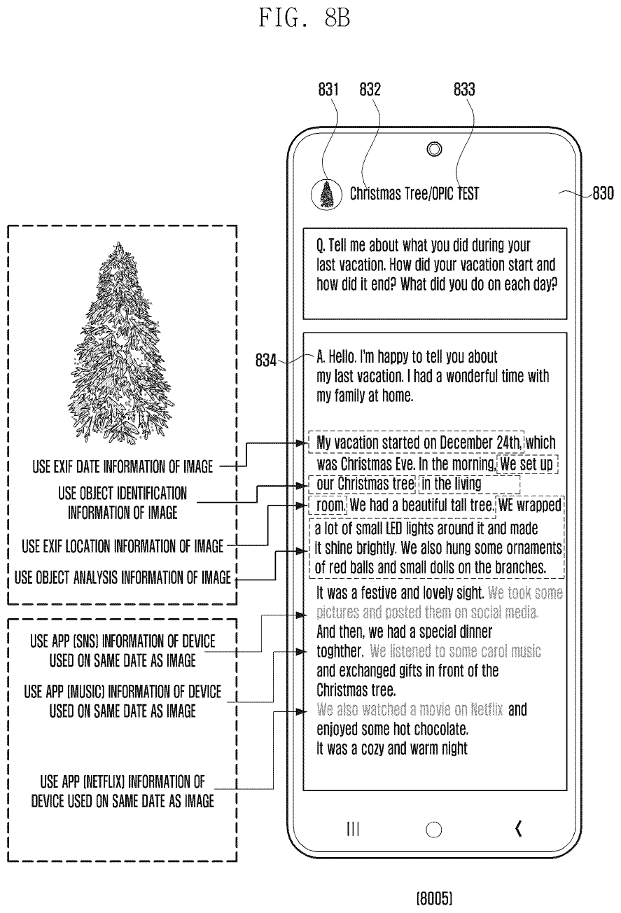

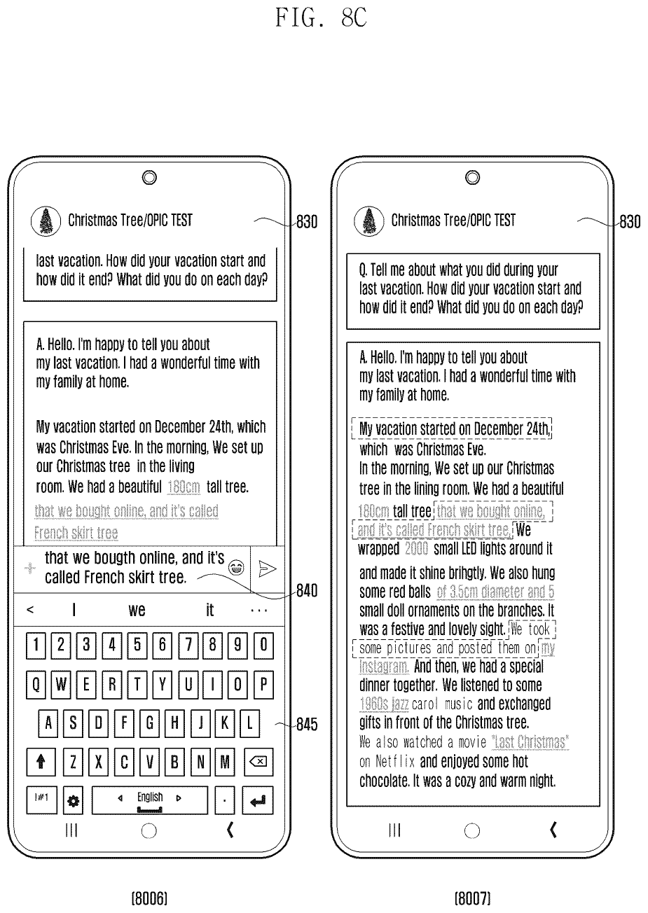

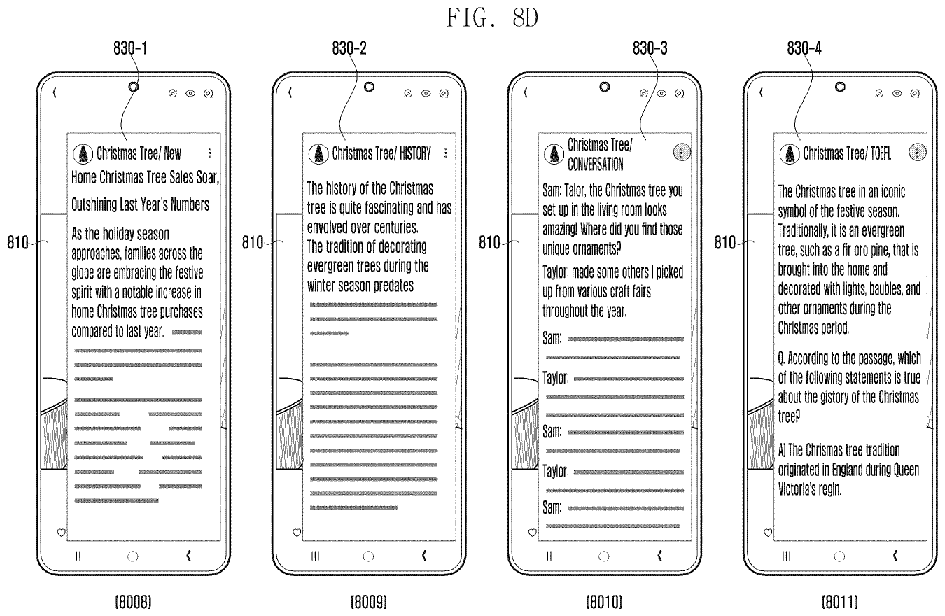

FIGS. 8A, 8B, 8C and 8D are diagrams illustrating example user display screens supporting AI content services of an electronic device according to various embodiments. FIGS. 8A, 8B, 8C and 8D (which may be referred to as FIGS. 8A to 8D) illustrate an example of supporting AI content services via a gallery application, and these are illustrative only and embodiments of the disclosure may be applied to other applications.

Referring to FIGS. 8A to 8D, the electronic device 101 according to an embodiment may execute a gallery application to display a first image (or first content) 810 on a display, as shown in screen <8001>. The electronic device 101 may receive a user input 812 of selecting an object (e.g., a Christmas tree object) 811 included in the first image 810.

As shown in screen <8002>, the electronic device 101 may separate and display (e.g., display a contour), using an object separation function, an object for the first image 810 displayed on the display based on the user input 812 of selecting the object 811, and may display an image-related menu UI 815. The electronic device 101 may display an AI content menu UI 820, based on an input of selecting an AI item 816 from the image-related menu UI 815.

The electronic device 101 may receive an input 821 of selecting an AI content generation item in the AI content menu UI 820.

According to an embodiment, the electronic device 101 may, in response to the input of selecting an object in the image, omit the image-related menu UI 815 and provide only an AI content menu UI 820.

The electronic device 101 may generate AI content (e.g., AI educational content) associated with the first image 810 and/or the object 811, based on an input 821 of selecting an AI content generation item. The electronic device 101 may display, on the display, information 825 indicating that AI content is being generated, as shown in screen <8003>.

The electronic device 101 may analyze the first image 810 and the object 811 to extract first information (or content data). For example, the electronic device 101 may extract, as first information, analysis information (or analytical keywords) indicating the feature of the first image 810 (e.g., Christmas tree, red ball ornament, large number of small-sized LED bulbs, indoors, living room, etc.), and may extract additional information based on metadata of the first image (e.g., Dec. 24, 2022, 8:30 p.m., location information, focal length, magnification information, etc.) and/or metadata of the identified object (e.g., object identification information).

The electronic device 101 may extract second information (or personalization data) associated with the first information. For example, the electronic device 101 may extract, as second information, user app usage information (e.g., use of Music, SNS-Instagram apps on a smartphone device, etc.) associated with the date and time information (e.g., Dec. 24, 2022, 8:30 p.m.) among the additional information extracted from the first image, user profile information, or user learning setting information. Alternatively, based on location information (e.g., identification of a location such as my home/work), information about various external devices (e.g., TV, refrigerator, speakers, etc.) connected to the electronic device 101 or existing at the identified location (e.g., my home), usage information of applications used on the external devices (e.g., Netflix app on the TV device, Music app on the speaker device, etc.) (e.g., watching the Last Christmas movie on the Netflix app at 10:00 p.m. on Dec. 24, 2022, and playing multiple carols, including Happy Holiday by Andy Williams and The Christmas Waltz by Peggy Lee, on the Music app on Dec. 24, 2022), the electronic device 101 may extract context information.

According to an embodiment, the electronic device 101 may generate a prompt for AI content generation using at least one of the first image, the first information, and the second information. The electronic device 101 may transfer the prompt and a DB (e.g., a universal content DB 211 and/or a personalized AI content DB 212) to the input of an AI content generation model, and may generate AI content associated with the first image and personalized using the AI content generation model.

The electronic device 101 may display a generated AI content 830 on the display, as shown in screen <8004>. For example, the AI content 830 may include an image of an object 831 recognized by a user or automatically, object identification information 832, a type 833 of the generated AI content, and a content description 834.

According to an embodiment, the electronic device 101 may display the AI content 830 in a pop-up window as shown in screen <8004>, or may switch the AI content 830 to be displayed in a full screen (e.g., a foreground) as shown in screen <8005>.

According to an embodiment, the electronic device 101 may apply different visual effects (e.g., color, size, shape, font, etc.) to a content description 834 and display so that text of the content description is visually distinguished according to the source information of the content description 834. For example, the AI content may include data such as the following Table 1.

TABLE 1

| Object | |
|---|---|
| identification | |
| information | Christmas Tree |
| AI Content Language | English |
| AI content type | OPIC TEST |
| Content description | Q.•Tell•me•about•what•you•did•during•your•last•vacation.•How•di [symbol] |
| | your•vacation•start•and•how•did•it•end?•What•did•you•do•on•each [symbol] |
| | day? [symbol] |
| | [symbol] |
| | A.•Hello,•I'm•happy•to•tell•you•about•my•last•vacation.• |
| | I•had•a•wonderful•time•with•my•family•at•home. |
| | [symbol] |
| | My•vacation•started•on•December•24th,•which•was•Christmas• |
| | Eve.• [symbol] |
| | [symbol] |
| | In•the•morning.•We•set•up•our•Christmas•tree•in•the•living• |
| | room.•We•had•a•beautiful•tall•tree.•We•wrapped•a•lot•of•small [symbol] |
| | LED•lights•around•it•and•made•it•shine•brightly.•We•also• |
| | hung•some•ornaments•of•red•balls•and•small•dolls•on•the• |
| | branches.•It•was•a•festive•and•lovely•sight.• [symbol] |
| | [symbol] |
| | We•took•some•pictures•and•posted•them•on•social•media.• [symbol] |
| | And•then,•we•had•a•special•dinner•together.• [symbol] |
| | We•listened•to•some•carol•music•and•exchanged•gifts•in•front•of• |
| | the•Christmas•tree.•We•also•watched•a•movie•on•Netflix•and• |
| | enjoyed•some•hot•chocolate.•It•was•a•cozy•and•warm•night. [symbol] |

[symbol]

indicates data missing or illegible when filed

The content description may include text generated by the AI content generation model, text generated by first information extracted in association with the content, and text generated by second information extracted in association with the user or the electronic device.

For example, the electronic device 101 may display the content generated by the AI model (e.g., Hello, I am happy to tell you about my last vacation. I had a wonderful time with my family at home, which was Christmas Eve, etc.) in black, and the content generated by the first information (e.g., My vacation started on December 24th, We set up our Christmas tree in the living room. We had a beautiful tall tree, etc.) in purple (or bold), and the content generated by the second information (e.g., We took some pictures and posted them on social media, We listened to some carol music, etc.) in blue (or italicized), but this is just an example.

According to an embodiment, the electronic device 101 may, in case that some text is selected from the content description 834, provide a UI (not shown) that guides source information about whether the selected text has been generated based on what type of information (e.g., first information or second information), as shown in screen <8005>. For example, in case that the user selects “We set up our Christmas tree in the living room”, the electronic device 101 may additionally display a UI indicating that the description is based on “object identification information of the image”. In another example, in case that the user selects “We listened to some carol music”, the electronic device 101 may additionally display a UI indicating that the description is based on “app (music) information of the electronic device used on the same date as the image”.

The electronic device 101 may display an AI content-related additional function menu UI 836, based on an input of selecting an additional function display item 835 for the AI content 830 shown in screen <8004>. For example, the additional function menu UI 836 may include at least one of a content description editing item, a word learning item, a grammar learning item, a similar AI content generation item, a speech practice item, and other types of content generation items, but this is only an example.

Based on an input 837 of selecting the content description editing item, the electronic device 101 may perform switching to an AI content editing UI screen 840, which provides a text input area 840 and a keyboard area 845, as shown in screen <8006>. The user may edit/modify the description of the AI content 830 by inputting text through the keyboard area 845. For example, the user may additionally input “180 cm, that we bought online, and it's called French skirt tree.”, etc. to the AI content description. Screen <8007> illustrates the AI content 830 in which the content description is modified by the user.

According to an embodiment, the electronic device 101 may apply different visual effects (e.g., red marking or underlining) to text for which the content description has been modified or added by a user so that the text is visually distinguished from other text. For example, the result data obtained by the user editing the AI content may be as shown in Table 2 below.

TABLE 2
Q.•Tell•me•about•what•you•did•during•your•last•vacation.•How•did•your•vacation•start•and•
how•did•it•end?•What•did•you•do•on•each•day?

[symbol]

[symbol]

A.•Hello,•I'm•happy•to•tell•you•about•my•last•vacation.• [symbol]
I•had•a•wonderful•time•with•my•family•at•home.

[symbol]

[symbol]

My•vacation•started•on•December•24th,•which•was•Christmas•Eve.•

[symbol]

[symbol]

In•the•morning,•We•set•up•our•Christmas•tree•in•the•living•room.•We•had•a•beautiful•
180 cm•tall•tree•that•we•bought•online,•and•it's•called•French•skirt•tree.•We•wrapped•
2000• [symbol] •small•LED•lights•around•it•and•made•it•shine•brightly.•We•also•hung•
some•ornaments•of•red•balls•of•3.5 cm•diameter•and•5•small•dolls•on•the•branches.•It•
was•a•festive•and•lovely•sight.•

[symbol]

[symbol]

We•took•some•pictures•and•posted•them•on• [symbol] •my•Instagram.• [symbol]
And•then,•we•had•a•special•dinner•together.• [symbol]
We•listened•to•some•1960s•Jazz•carol•music•and•exchanged•gifts•in•front•of•the•Christmas•
tree.•We•also•watched•a•movie•“Last•Christmas”•on•Netflix•and•enjoyed•some•hot•
chocolate.•It•was•a•cozy•and•warm•night.

[symbol]

[symbol]

According to an embodiment, the electronic device 101 may generate and provide different types of AI content based on the set education type. For example, the electronic device 101 may generate news-type AI content 830-1 associated with the first image 810, as shown in screen <8008> of FIG. 8D, or may generate history-type AI content 830-2 associated with the first image 810, as shown in screen <8009>. Alternatively, the electronic device 101 may generate conversation-type AI content 830-3 associated with the first image 810, as shown in screen <8010>, or may generate TOEFL-type AI content 830-4, as shown in screen <8011>.

In an embodiment, the electronic device 101 may randomly select a type of AI content to generate and provide AI content in case that there is no AI content type setting information. When it is analyzed that there is a type of AI content preferred by a user learning pattern, the electronic device 101 may be configured to preferentially generate the preferred type of AI content.

The electronic device 101 according to an embodiment may select a type of AI content that matches the user and/or the situation of the electronic device, based on the second information or personalization data (e.g., user profile information, context information, and user app usage information), and generate AI content with the selected type.

The electronic device 101 according to an embodiment may, in case that an input of selecting “another type of content generating item” is received through the additional function menu UI while a particular type of AI content is displayed, generate a different type of AI content and display the different type of AI content.

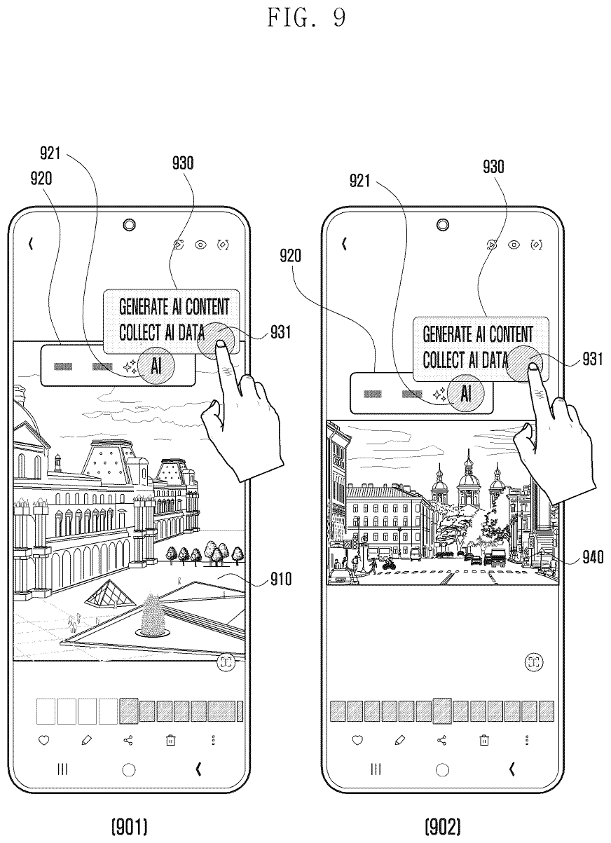

FIG. 9 is a diagram illustrating example user interface screens for collecting an AI content DB of an electronic device according to various embodiments.

Referring to FIG. 9, according to an embodiment, the electronic device 101 may support an AI data aggregation function to generate personalized AI content.

For example, as shown in screen <901>, the electronic device 101 may display an image-related menu UI 920, based on a user input of selecting a first image 910 or an object in the first image 910, and display an AI content menu UI 930, based on an input of selecting an AI item 921 from the image-related menu UI 920 item.

The electronic device 101 may, based on an input 931 of selecting an AI data collection item, extract first information (e.g., analysis information and additional information) associated with the first image 910 and/or objects in the first image 910, or extract information on the memory location in which the corresponding image is located, and store the same in a personalized AI content DB. For example, the first image 910 shown in screen <901> and a second image 940 shown in screen <902> may be content captured at different times on the same date at the same location (e.g., Dec. 10, 2019, Salzburg Christmas Market, Austria). The electronic device 101 may collect the first image 910 and the second image 920 through the AI data collection item.

According to an embodiment, the electronic device 101 may store the content collected through the AI data collection item in the personalized AI content DB.

According to an embodiment, the electronic device 101 may extract analysis information (e.g., main-object identification information, keywords indicating a place, and keywords indicating a mood) or additional information (e.g., seasonal information based on a date, etc.) analyzed by correlating the first image and the second image, and store the information in the personalized AI content DB.

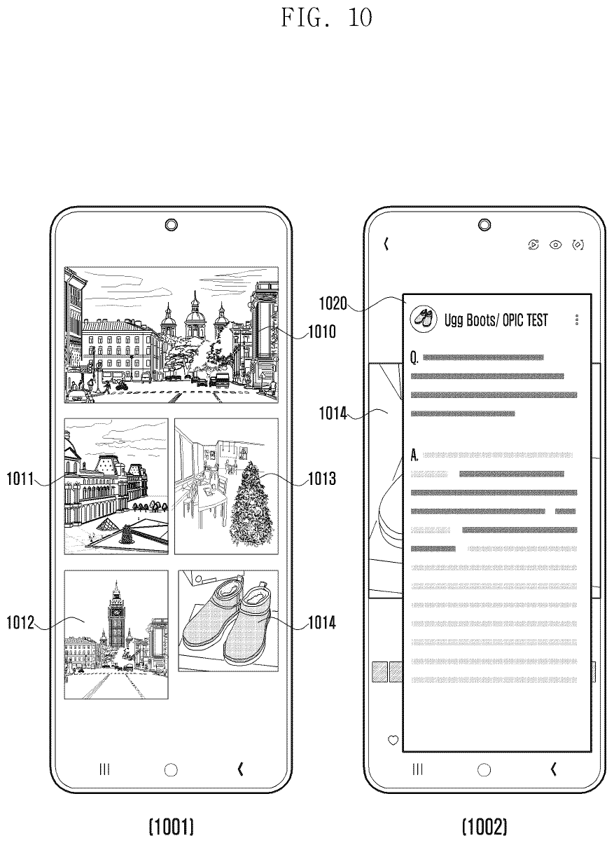

FIG. 10 is a diagram illustrating example user interface screens for collecting a content DB of an electronic device and generating AI content according to various embodiments.

Referring to FIG. 10, the electronic device 101 according to an embodiment may collect a first image 1010, a second image 1011, a third image 1012, a fourth image 1013, and a fifth image 1014 using the AI data collection item described in FIG. 9, as shown in screen <1001>. The first image 1010, the second image 1011, the third image 1012, the fourth image 1013, and the fifth image 1014 may be content captured at the same location (e.g., Salzburg Christmas Market, Austria) on the same date (e.g., Dec. 10, 2019).

After performing the “Collect AI data” operation on the four images except for the fifth image 1014, a user may select an AI content generation menu while the fifth image 1014 is displayed on a display.

For example, the electronic device 101 may identify an object (e.g., boots) for the fifth image 1014, extract image capturing date (e.g., Dec. 10, 2019) and location information (e.g., Salzburg, Austria) from the metadata information of the image, and then extract the four pre-stored images (e.g., the first image 1010, the second image 1011, the third image 1012, and the fourth image 1013) and information (e.g., second information) associated with them from the personalization data or personalized AI content DB using the extracted date information and location information. The electronic device 101 may generate AI content 1020, based on the four pre-stored images, the user-selected fifth image 1014, and first information (e.g., analysis information and additional information) for each image.

The electronic device 101 may display the generated AI content on the display, as shown in screen <1002>. For example, an example of the description of the AI content generated using the plurality of collected images may be as shown in Table 3 below.

TABLE 3
Q. Tell me about a memorable or unforgettable experience you had while traveling
abroad. what happen and why was the experience memorable?
A. One of the most memorable experiences I had while traveling abroad was when I
visited Salzburg, Austria about three years ago. It was a snowy day in December, and I
decided to go to the Hohensalzburg Fortress. I took a funicular up to the castle and
explored its history and architecture. I also enjoyed the panoramic view of the city and
the mountains from the castle.
When I came down from the castle, it was almost sunset and the main square was filled
with a beautiful Christmas market. There was a big Christmas tree in the center covered
with snow. It was a magical scene that made me feel like I was in a fairy tale.
One of the things that caught my eye was a pair of warm Ugg boots that were on sale. I
decided to buy the boots, which were very cozy and comfortable. I think buying the Ugg
boots was the highlight of my trip, because they reminded me of the wonderful
experience I had in Salzburg.

The underlined text of the content description in Table 3 may be description related to the first information (image analysis information and additional information).

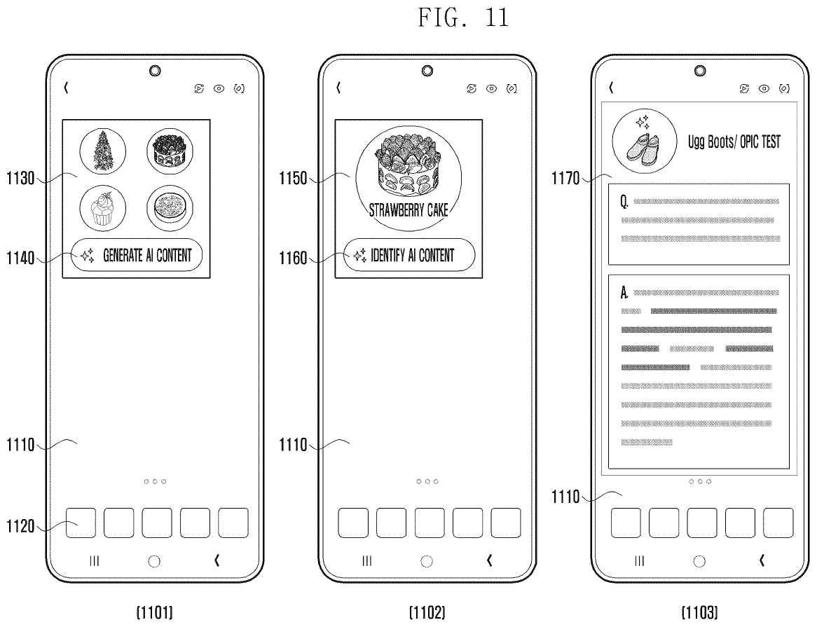

FIG. 11 is a diagram illustrating example user interface screens supporting an AI content service of an electronic device according to various embodiments.

Referring to FIG. 11, the electronic device 101 according to an embodiment may support a function of generating AI content or displaying AI content using widgets.

The electronic device 101 may display various types of widget objects in connection with AI content generation on a home screen 1110, on which icon objects 1120 corresponding to applications or functions are displayed. Screen <1101> may be an example in which a first widget 1130 including a plurality of images (or thumbnails) collected through an AI data collection function is displayed, and an AI content generation item 1140 is added to the first widget 130 to provide a function of generating AI content. Screen <1102> may be an example in which a second widget 1150 for identifying the generated AI content is displayed, and an AI content identifying item 1160 is added to a second widget 1150 to provide a function of calling AI content using the widget. Screen <1103> may be an example of providing, on the home screen 1110, a third widget 1170 of a form capable of identifying the content description of the generated AI content.

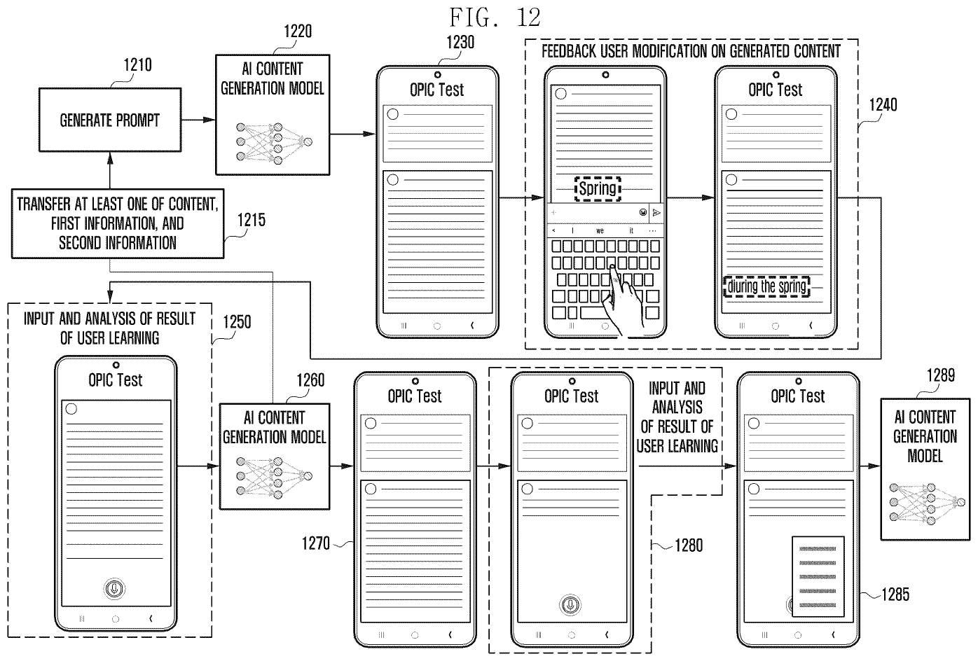

FIG. 12 is a diagram illustrating an example method of supporting AI content services of an electronic device according to various embodiments. FIG. 12 may illustrate a process of analyzing the result of learning the generated AI content (e.g., AI educational content) and developing the AI content into personalized or tailored content based on personal characteristics according to the result of the analysis.

Referring to FIG. 12, the electronic device 101 according to an embodiment may support a function of updating AI content (or developing into personalized AI content) based on a user's personal characteristics by reflecting the user's learning results in the generated AI content (e.g., AI educational content).

For example, in operation 1210, the electronic device 101 may generate a prompt for generating AI content associated with first content. Prior to generating the prompt, in operation 1215, the electronic device 101 may transfer at least one of the first content, first information associated with the first content or an object included in the first content, and second information associated with the user/electronic device to a prompt generator.

In operation 1220, the electronic device 101 may generate AI content (e.g., AI content of OPIC test type) by transferring a prompt requesting generation of AI content of the OPIC test type in connection with the first content to an AI model (e.g., AI content generation model).

For example, the AI content of the OPIC test type may include examples of questions and answers. The electronic device 101 may extract second information associated with the first content via the personalization data, and generate, based on the extracted second information, information that a user has experienced or is expected to experience as content description for the examples of answers.

In operation 1230, the electronic device 101 may display AI content of the OPIC test type on the display.

In operation 1240, the electronic device 101 may obtain user modification information (e.g., edition information) for the AI content. For example, in case that the generated AI content includes content about a user experience, the user may modify or change content that is incorrect or that the user wishes to modify using an AI content editing function.

The electronic device 101 may reflect (or feedback) the description modified or edited by the user to generate customized OPIC tests or example sentences.

In operation 1250, the electronic device 101 may receive the result of user learning (e.g., answer data or speech data) for the AI content and analyze the learning patterns.

In operation 1260, the electronic device 101 may generate new AI content by reflecting the analyzed learning patterns (e.g., detecting sounds or words that the user has difficulty pronouncing) based on the result of learning, and in operation 1270, the electronic device 101 may output the newly generated AI content to the display.

For example, the electronic device 101 may evaluate the user's learning level based on the result of learning and analyze the user's utterance data in answering the OPIC tests, and generate new AI content that changes the content description of the examples of answers (e.g., suggesting words that are easier for the user to say by analyzing the user's pronunciation).

The electronic device 101 may analyze the user's utterance with respect to example sentences of the AI content and, in case that grammatical errors are repeated, may generate AI content for grammar or speech repetition education and provide the generated AI content to the user. The electronic device 101 may generate the AI content by tuning the level of description (e.g., example sentences) of the AI content to match the user's learning level by reflecting a configured educational goal.

In operation 1280, the electronic device 101 may receive and analyze the result of learning for the newly generated AI content to continuously perform updating of the AI content.

In operation 1285, the electronic device 101 may receive inputs associated with an additional function associated with AI content (e.g., a content description editing item, a word learning item, a grammar learning item, a similar AI content generation item, a speech practice item, other types of content generation item, etc.). In operation 1289, the electronic device 101 may generate AI content corresponding to the additional function.

According to an embodiment, the electronic device 101 may support a function of generating personalized AI content (or AI educational content) based on user characteristics in connection with video content.

For example, the electronic device 101 may generate AI content of a video type based on data stored in a DB manager in case of obtaining information (e.g., second information) indicating that a user frequently studies video lectures. In the case of the video type, the electronic device may generate the AI content using a user's avatar or an image of a person included in the stored image content in correspondence with a person. When displaying the video-type AI content, the electronic device 101 may also provide a summary of the AI content in text format.

A method of supporting an AI content service of an electronic device according to an example embodiment may include: identifying an object included in first content displayed on a display, based on a request to generate artificial intelligence (AI) content; obtaining first information associated with at least one of the object or the first content, and second information associated with the electronic device or a user; generating a prompt for input to a generative AI model, based on at least one of the first content, the first information, and the second information; and generating second content, which is associated with the first contest and personalized, using generative AI having an input of the generated prompt.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a display;
at least one processor, comprising processing circuitry; and
a memory configured to store instructions executable by the at least one processor,
wherein at least one processor, individually and/or collectively, is configured to execute the instructions and to cause the electronic device to:
based on a request to generate artificial intelligence (AI) content, identify an object included in first content displayed on the display;
obtain first information associated with at least one of the object or the first content, and second information associated with the electronic device or a user;
generate a prompt for input to a generative AI model, based on at least one of the first content, the first information, and the second information; and
generate second content, associated with the first contest using a generative AI model having an input of the generated prompt.

2. The electronic device of claim 1, wherein the second content comprises AI content, educational content, or learning content.

3. The electronic device of claim 1, wherein at least one processor, individually and/or collectively, is configured to cause the electronic device to:
extract, as the first information, at least one of object identification information, a content-describing keyword obtained by analyzing the first content or the identified object, and additional information based on metadata of content; and
extract, as the second information, at least one of user learning setting information, user app usage information, user profile information, and context information.

4. The electronic device of claim 3, wherein at least one processor, individually and/or collectively, is configured to cause the electronic device to select and extract the second information associated with the first information.

5. The electronic device of claim 1, wherein at least one processor, individually and/or collectively, is configured to cause the electronic device to, as an operation of identifying the object, identify the object through an input of selecting the object included in the first content or through recognition of the object in the first content.

6. The electronic device of claim 1, wherein at least one processor, individually and/or collectively, is configured to cause the electronic device to display the generated second content on the display, wherein the second content comprises a content or object image, object identification information, a type of generated AI content, and a content description.

7. The electronic device of claim 6, wherein at least one processor, individually and/or collectively, is configured to cause the electronic device to display the second content in the form of a pop-up window overlaid on the first content, or to switch the second content into the form of a foreground and then display the switched second content.

8. The electronic device of claim 6, wherein at least one processor, individually and/or collectively, is configured to cause the electronic device to, based on source information of the content description being different, apply different visual effects to the text of the content description and display the text of the content description to be visually distinguished according to the source information.

9. The electronic device of claim 6, wherein at least one processor, individually and/or collectively, is configured to cause the electronic device to:
obtain edition information in which the AI content associated with the second content has been modified or changed, or feedback information regarding the result of learning of the second content; and
update the second content, based on the obtained edition information or feedback information.

10. The electronic device of claim 1, wherein at least one processor, individually and/or collectively, is configured to cause the electronic device to, based on selecting the first content displayed on the display, display a second content generation item and a data collection item on at least a part of the display and, based on selection of the second content generation item or recognition of the object included in the first content, receive the request to generate the AI content.

11. A method of supporting artificial intelligence (AI) content service of an electronic device, the method comprising:
based on a request to generate AI content, identifying an object included in first content displayed on a display;
obtaining first information associated with at least one of the object or the first content, and second information associated with the electronic device or a user;
generating a prompt for input to a generative artificial intelligence (AI) model, based on at least one of the first content, the first information, and the second information; and
generating second content, associated with the first contest using generative AI having an input of the generated prompt.

12. The method of claim 11, wherein the second content comprises AI content, educational content, or learning content,
wherein the first information comprises at least one of object identification information, a content-describing keyword used for analyzing the first content or the identified object, and additional information based on metadata of content; and
wherein the second information comprises at least one of user learning setting information, user app usage information, user profile information, and context information.

13. The method of claim 11, wherein the obtaining of the first information associated with at least one of the object or the first content and the second information associated with the electronic device or the user comprises selecting and extracting the second information associated with the first information.

14. The method of claim 11, wherein the identifying of the object comprises identifying the object through an input of selecting the object included in the first content or through recognition of the object in the first content.

15. The method of claim 11, further comprising displaying the generated second content on the display,
wherein the second content comprises a content or object image, object identification information, a type of generated AI content, and a content description.

16. The method of claim 15, wherein the displaying of the second content on the display comprises, based on source information of the content description being different, applying different visual effects to the text of the content description and displaying the text of the content description to be visually distinguished according to the source information.

17. The method of claim 11, further comprising:
based on the displaying of the second content on the display,
obtaining edition information in which the AI content associated with the second content has been modified or changed, or feedback information regarding the result of learning of the second content; and
updating the second content, based on the obtained edition information or feedback information.

18. A non-transitory computer-readable recording medium having recorded thereon a computer program which, when executed by at least one processor, individually and/or collectively, of an electronic device, causes the electronic device to perform operations comprising:
based on a request to generate artificial intelligence (AI) content, identifying an object included in first content displayed on a display;
obtaining first information associated with at least one of the object or the first content, and second information associated with the electronic device or a user;
generating a prompt for input to a generative AI model, based on at least one of the first content, the first information, and the second information; and
generating second content, associated with the first contest using generative AI having an input of the generated prompt.
